(19) United States
(12) Patent Application Publication
(10) Pub. No.: US 2017/0339846 A1
(43) Pub. Date: Nov. 30, 2017

(54) APPARATUS AND METHOD FOR AUTONOMOUS CONTROLLED ENVIRONMENT AGRICULTURE

(71) Applicant: RoBotany Ltd., Pittsburgh, PA (US)

(72) Inventors: Austin Blake LAWRENCE, Kalamazoo, MI (US); Daniel Ryan SEIM, Pittsburgh, PA (US)

(21) Appl. No.: 15/604,343

(22) Filed: May 24, 2017

Related U.S. Application Data
(60) Provisional application No. 62/340,952, filed on May 24, 2016.

(51) Int. Cl. A01G 9/24; A01G 25/16; A01G 9/14; A01G 9/10; A01G 9/02; A01G 7/04; G06K 7/10; A01G 1/00

(52) U.S. Cl. CPC A01G 9/24; G06K 7/10366; G06K 7/10158; A01G 25/16; A01G 1/001; A01G 9/1066; A01G 9/022; A01G 7/045; A01G 9/14

(57) ABSTRACT

Disclosed herein is an apparatus and method of autonomous Controlled Environment Agriculture (CEA) comprising a fully autonomous Growing environment. More specifically, disclosed herein is an apparatus and method in which a plurality of Tray assembly may be stored and manipulated within a Track assembly that is configured within a Rack Assembly through the motivational input of at least one antagonistic pair of Carriage-mounted manipulators. With the Template Frame consisting of a low friction bearing surface to orient within a Track assembly, it may be configured to satisfy various utilities necessary within the farm, such as but not limited to: housing grow media for the cultivation

### CROSS-REFERENCE TO RELATED APPLICATION

This application claims the benefit under 35 U.S.C. 119 §(e) of the earlier filing date of U.S. Provisional Patent Application No. 62/340,952, filed on May 24, 2016, the entire contents of which are incorporated herein by reference.

### FIELD OF THE INVENTION

The present disclosure relates to an apparatus and method for autonomous Controlled Environment Agriculture (CEA), including without limitation for the purpose of cultivation of organic produce and other organic or natural products and in vertical farming applications. The disclosed apparatus and method can also be utilized for more general application in the fields of agriculture, material handling, and warehousing, including without limitation, modular pallet warehousing.

### BACKGROUND

Controlled Environment Agriculture (CEA) is an evolving technique for the precision cultivation of organic produce through the artificial control of influential environmental factors. An appeal to facilitate the desirable outcomes of growth, this type agriculture may require the regulation of parameters pertaining to atmospheric, nutritional, spatial, or electromagnetic qualities. In doing so, a precise understanding of an organic system's overall production with respect to time is much more attainable. Systems like these can vary in size, ranging from a household appliance, to a standard freight shipping container, to a 10,000 square-meter warehouse, to a multi-hectare greenhouse. CEA systems are typically equipped with a general selection of actuators and sensors to monitor and control the environment.

In recent times, the technique has seen market potential in the cultivation of leafy or herbal produce, but the method has historically also suited for other organic applications, such as production of ornamentals, fungi, simple organisms, and protein sources. CEA offers the appeal of being resistant to growth-inhibiting factors, such as droughts, famine, floods, or winters. Because of this resiliency, consistent, year-round production is possible for a wide range of geographic scenarios, including urban, desert, artic, and deep space regions.

Typically, CEA systems running at a commercial capacity require a wide range of manual tasks to be performed by farmhands on a daily basis. These responsibilities may include the harvesting, cleaning, creation, inspection, and moving of product, the maintenance, sensing, control, and logistical planning of the environment, and the analysis of any data that may be subsequently collected. Despite being computer-controlled and with sensory feedback, CEA systems have many logistical points of failure that require technical skills from the farmhands in order to maintain. Appropriately so, commercial CEA systems are sometimes referred to as “plant factories” for their resemblances to manufacturing environments.

In industries pertinent to the distribution of inventory, autonomous warehousing has grown to prominence with the notion of a distributed robotic network to satisfy the last-mile issue that is often faced within large centers. In the 1970's, Autonomous Storage and Retrieval (ASRS) systems rose to prominence and were complimented with general conveyance of varying complexity to create semi-autonomous zones within the warehouse through the use of a manual crane operator. Over decades of innovation, fully autonomous warehousing has seen continued interest due to improved accessibility of affordable, functional robotic resources, such as actuators, sensors, embedded hardware, and control algorithms. New embodiments and methods include a fleet of freely-driven robots within a warehouse that have created further evolution in automation, now looking towards topics of dextrous manipulation, rich image classification, and swarm optimization.

Despite the prevalence in autonomous mechanization that has benefitted warehousing, few solutions exist that are appropriate for CEA embodiments. Tasks in CEA systems are largely manual, requiring redundant work from human laborers. These tasks, often worsened by day-long repetition, excessive amounts of walking, and the frequent use of vertical lifts, all attribute to a significant portion of operational expenses for a CEA. As reported in Newbean Capital's 2015 white paper, “Robotics and Automation in Indoor Agriculture,” CEAs in the vegetative green industry spend about 26% of their operational expenses on human labor, second to electricity at 28%. Because a significant portion of resources are dedicated to accessing manual labor, it is difficult for CEA operators to justify committing even more resources to the meticulous capture and logging of data. A consequence to this, optimization suffers, and little may be done to reduce operating expenses in areas such as electrical, nutritional, and water usages.

A growing number of specialized systems have been proposed in the interest of improving the operation of CEA systems. For example, Just Greens' US2014/0137471 embodiment employs the use of a fabric-like material of particular absorptive and wicking parameters that may be mounted onto a variety of tensioning and conveying systems, but is best suited for aeroponic environments where suspended roots are given adequate clearance to grow. As another example, Living Greens Farm's U.S. Pat. No. 9,474,217B2 embodiment contains a mobile track system for large A-frames containing plants to transverse along, as well as a mobile irrigation system, but it does not offer irrigation methods differentiated from aeroponics. Lastly, Urban Crop Solutions' WO2017012644(A1) describes an industrial plant growing facility, but limits scope to the cultivation only of green produce within flat, off-the-shelf trays. No standardization exists which offers broad versatility and inspection in a CEA environment for varying applications.

As these mentioned embodiments do bring improvements to CEA in practice, their function is often very specific to the type of produce that is being cultivated and would require substantial capital investment to convert infrastructure for alternative forms of agriculture. In addition, some embodiments make frequent requirement for workers to operate in precarious situations that may involve carrying a large, potentially wet, cumbersome pallet of produce on ladders or scissor lifts. Lastly, all of these inventions do not facilitate the measurement of produce quality at a particular site of production without first requiring substantial manipulation from a human, or automated mechanism, to deliver the organic material of interest to a stationary sensory station.

Therefore, for the sake of worker safety, production efficiency, and quality of data acquisition, there exists a growing need to facilitate the distributed handling and transport of material within CEA systems. More specifically, a need is present for an autonomous handling and transport system that manipulates units of material of particular form factor to a new destination within a CEA system.

The invention disclosed within contemplates an apparatus and method for autonomous inventory management for applications particular to CEA. The system, generally consisting of a plurality of tray assemblies (40) configured linearly within a plurality of track assemblies (18) within a rack (11) within an environmentally-controlled environment, may receive autonomous forceful input from a carriage-mounted manipulator (79) to add, subtract, index, or transfer tray assemblies (40) within the growing environment (10).

The template frame (41), having features for compressive or tensile input along a serial chain of the like, orients onto a pair of tracks (19) of at least one track assembly (18) with low-friction bearing surfaces that are affixed to the template frame (41). A tag (47), consisting of an RFID chip or optical feature, allows for tracking from an inventory management system. Fasteners on the template frame (41) accept a frame insert (40) derivation that is pertinent to the particular CEA application of interest. An indexing face for the forceful input and manipulation from a carriage-mounted manipulator (79) allow the autonomous handling of product.

The frame insert (40), having mating features for orienting and affixing to the fasteners on a template frame (41), may be configured for a variety of scenarios that are pertinent to the particular CEA task. For example, one embodiment of a frame insert (40) may include a rigid frame along with tensioned fabric principally intended as a growing media for short, leafy or herbal produce. In another embodiment, the frame insert (40) may include an electronic enclosure to facilitate tasks such computation, energy generation and storage, wireless communication, controls, and sensing. Additional embodiments of the frame insert (40) may be configured for applications that are largely pertinent to CEA organic product, such as ornamental crops, medicinal crops, plants requiring anchoring at the base, vines, fungi, roots, simple organisms, carbohydrates, fats, and animal protein sources.

The track (19), having a plurality of flats that are parallel to the horizon, facilitates linear motion by providing a bearing surface for at least one low-friction mechanism on a template frame (41) to commute. In the preferred embodiment, two tracks (19) are oriented to be mirrored about a center plane perpendicular to the horizon within the rack (11) and do not provide a significant contribution to the structural integrity of the structure. In alternative derivations, the track (19) may be configured with multiple steps for additional mobile bodies to linearly move independently of one another, features for the confinement of mobile bodies, features for electrical or fluidic channels, or features for mounting hardware.

The track (19) may be configured as a track assembly (18) to achieve various functions pertinent to a specialized CEA system. For example, an embodiment illustrated herein contemplates an aeroponic configuration in which a flexible sheet (13) is formed and affixed to fit between a hat and track (19). Supporting hardware, such as aeroponic modules, a fluidic drain, a fluidic inlet, and at least two bulkheads and stiffeners are incorporated into said track assembly (18) embodiment. In another embodiment, a low pressure fluidic system may be derived consisting of a flexible sheet (13) to function as a channel for waste fluids, a fluidic drain and inlet, and fluidic emitters ( ) to deliver a chemical solution to tray assemblies (40). In exemplary embodiments, a track assembly (18) may be configured for applications relevant to the production of ornamentals crops, medicinal crops, plants requiring anchoring at the base, vines, fungi, roots, simple organisms, carbohydrates, fats, and protein sources.

In accordance with CEA system design, the apparatus may include peripherals to assist in regulating environmental parameters. A fertigation system may use a combination of pumps, solenoids, filters, chemical reservoirs, and sensors to regulate and distribute a fluid of nutritional significance throughout the grow environment and more directly to tray assemblies (40). A lighting module can be used to provide supplemental light to living organisms, preferably through color and intensity-specified LED modules, and facilitate desirable growth on each tray assembly (40). Forced convective air flow may be included to ensure proper mixing of gasses, to improve thermal distribution, and to redirect undesired moisture away from plant canopies. In continuation of said embodiment and common knowledge, the apparatus is confined within an environmentally-controlled enclosure and is equipped with an air quality unit for the monitoring and regulation of atmospheric parameters within the grow environment ( ). These parameters may include the active control of relative humidity, temperature, particulate frequency and size through mechanical filtration, pathogen through UV treatment, and carbon dioxide supplementation. Contents within the enclosure are physically isolated from an outside environment and undergo a minimal number of air exchanges, thus satisfying the function as a CEA system. Enclosure embodiments may fit the form factor found in industrial warehousing, shipping containers, and greenhouses while still benefitting from the embodiment of this invention.

Exemplary embodiments are generally pertinent to the apparatus and method of autonomous inventory management in CEA systems through the active input of one or more carriage-mounted manipulators (79). In one embodiment, which is described in this document with the intent for illustration, an automated inventory management system is described for environments relevant to the cultivation of leafy or herbal produce inside facilities that are configured over multiple layers of plants grown within tray assemblies (40). In function, the manipulator (82) may navigate to a first location of interest, extend its linear extensor 0 and perform a grasping maneuverer by closing its clamps (86), forcibly push tray assemblies (40) configured within a track assembly (18), and insert said tray assembly (40) into a new respective location within a track assembly (18) within a rack (11), or processing line. In the preferred embodiment, the manipulator (82) may perform retrieval, indexing, and insertion functions to tray assemblies (40) within the growing environment (10), and may optionally operate tray assemblies (40) to or from a processing line.

### BRIEF DESCRIPTION OF THE DRAWINGS

FIG. 1 shows an overall apparatus of autonomous controlled environment agriculture according to the embodiment of the invention as a grow environment.

FIG. 2 shows a preferred embodiment of the template frame.

FIG. 3 shows one preferred embodiment of a tray assembly having a fabric frame insert

FIG. 4 shows one preferred embodiment of a tray assembly having a deep bin frame insert.

FIG. 5 shows one preferred embodiment of a tray assembly having a shallow bin frame insert.

FIG. 6 shows one preferred embodiment of a tray assembly having a net pot frame insert.

FIG. 7 shows one preferred embodiment of a tray assembly having a sensory and actuated frame insert.

FIG. 8 shows one preferred embodiment of a track assembly configured for high-pressure irrigation.

FIG. 9 shows one preferred embodiment of a track assembly configured for low-pressure irrigation.

FIG. 10 shows a profile view of one preferred embodiment of a track assembly configured for high-pressure irrigation.

FIG. 11 shows one preferred embodiment of a rack.

FIG. 12 shows one preferred embodiment of a rack.

FIG. 13 shows one preferred embodiment of a rack with walkways.

FIG. 14 shows a preferred embodiment of a carriage-mounted manipulator.

FIG. 15 shows an interaction of a carriage-mounted manipulator and a tray assembly.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

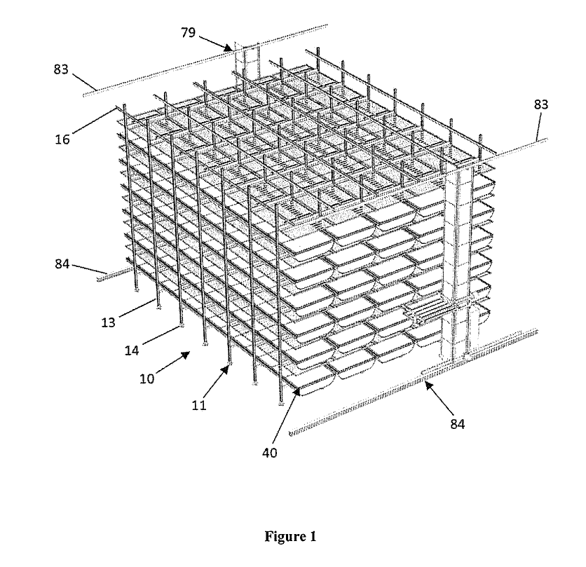

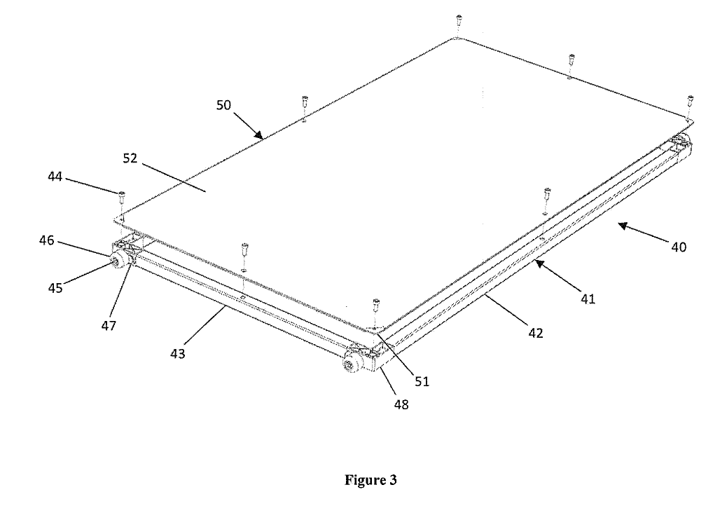

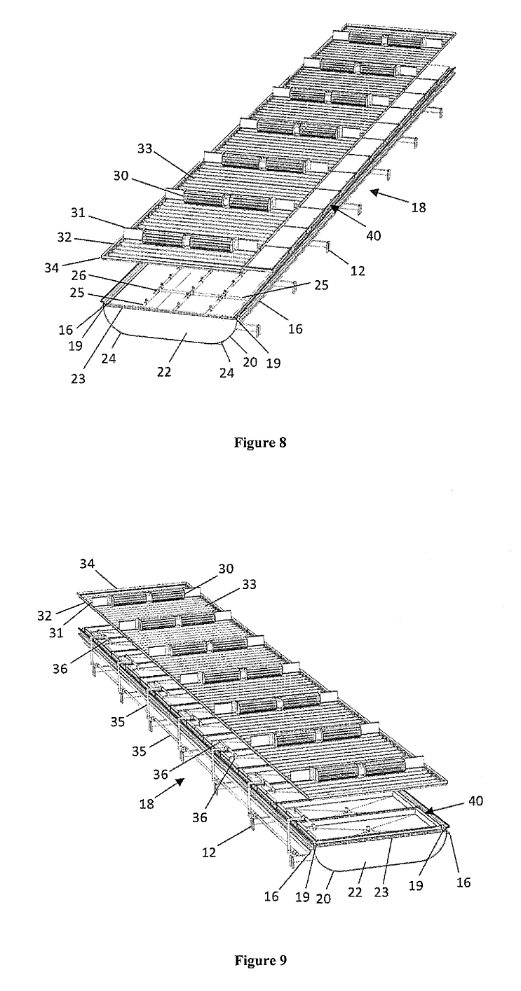

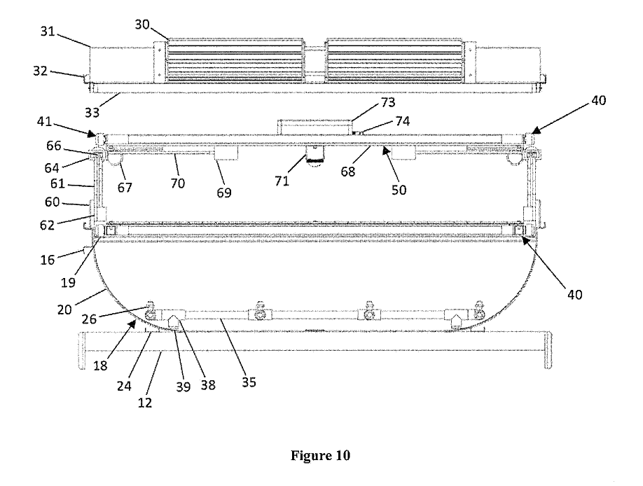

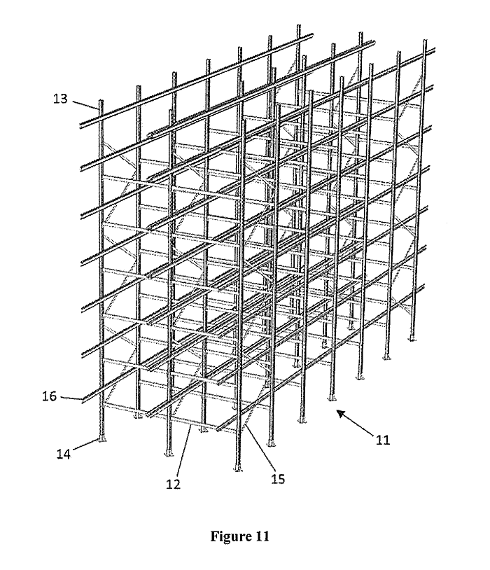

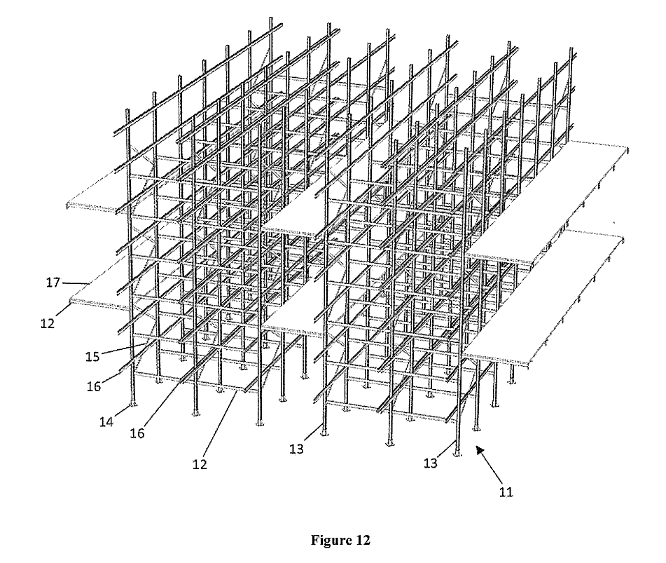

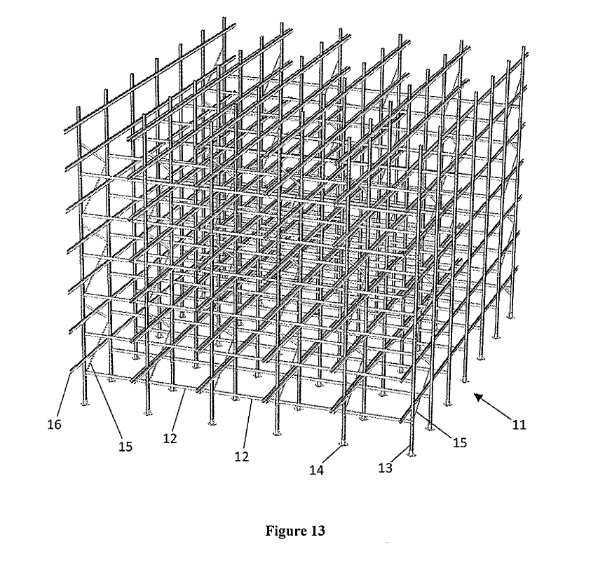

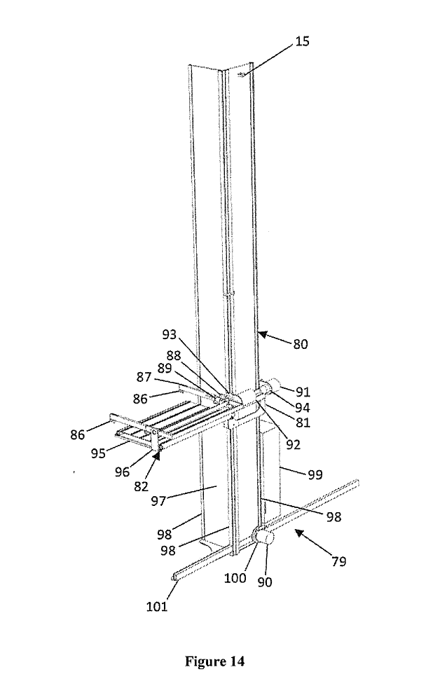

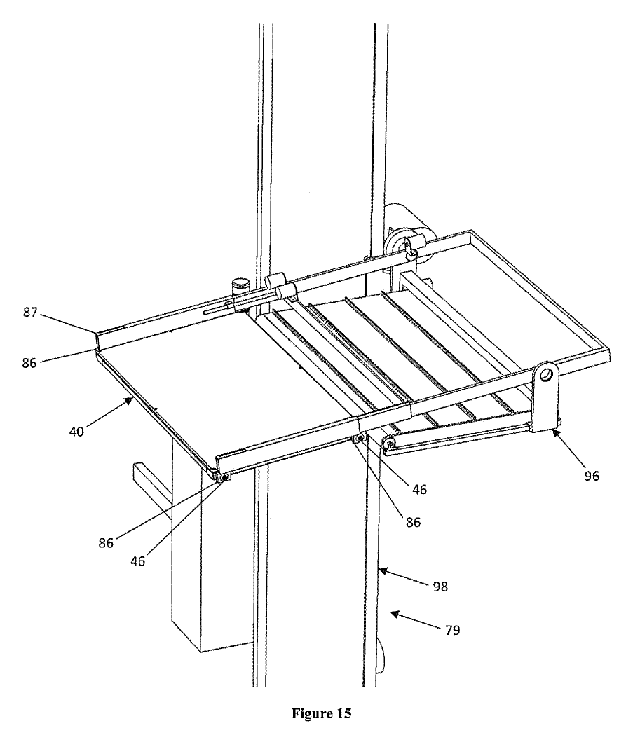

One preferred embodiment of the present invention, as depicted in FIG. 1, comprises a carriage-mounted manipulator (79), consisting of a carriage (80) which is further shown in a preferred embodiment in FIGS. 14 and 15, and a manipulator (82) which is further shown in preferred embodiments in FIGS. 1, 14, and 15 as being affixed to said carriage (80) through fastening to a mounting bracket. Further detail of the preferred embodiment consists of a rack (11) which is further shown in a preferred embodiment in FIGS. 1, 11, 12, and 13, a track assembly (18) which are further shown in a preferred embodiments in FIGS. 1, 8, 9 and 10, and tray assembly (40) comprising of a template frame (41) and frame insert (40), assuming a variety of utilities and embodiments demonstrated in FIGS. 3, 4, 5, 6, and 7, such as housing plant grow media for the cultivation of produce, a bin for retaining organic material, or a wireless sensory and actuation hub. The manipulator (82) may push or pull a tray assembly (40) through the forceful contact, or alternatively retrieve said tray assembly (40) through a multitude of grasping techniques, such as through the use of a clamp (86) directly to at least two wheels mounted to the template frame (41). Tags (47) on a rack (11) and the tray assembly (40) may assist the manipulator (82) and carriage (80) in localization and may also serve the function of tracking. As one manipulator (82) indexes a tray assembly (40), an antagonistic manipulator (82) may retrieve a tray assembly (40) to provide linear clearance along the track assembly (18). A multitude of tray assembly (40) and track assembly (18) derivations may be incorporated into a rack (11), offering sensory, sterilization, and actuation resources in addition to methods and apparatuses for the cultivation of produce.

As alluded to in the background section, vertical farms are burdened with human labored tasks. In incorporating a manipulator (82) with the wide range of functions possible by the template frame (41), laborious tasks, such as handling trays, sterilization, sensing, and data logging may be completely automated by machines along a processing line. Doing so reduces the need for human intervention in the growing environment (10), thus advancing towards autonomous controlled environment agriculture.

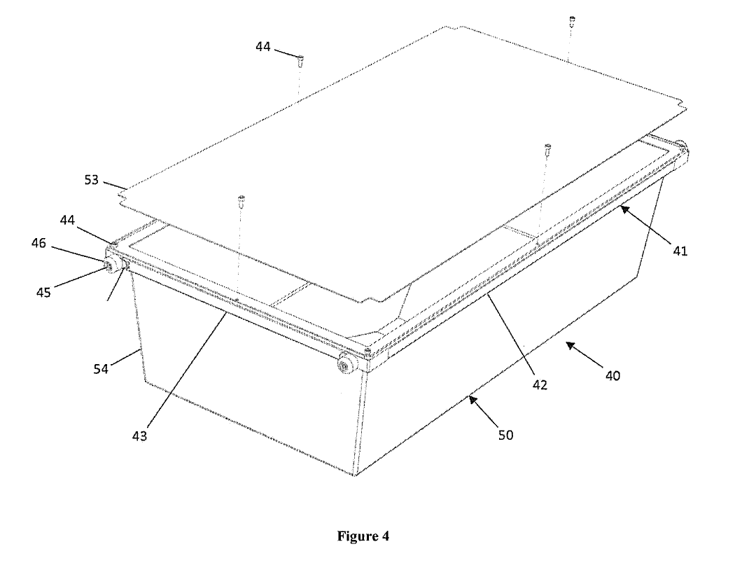

In another preferred embodiment, as shown in FIG. 4, the rack (11) is configured to provide attachment sites for the flange features of the trough runner (49), linear guides (12) for the carriage (80), horticultural lights (24), and the water reservoir (11). The trough runner (49) bears directly onto the rack runner (14), where load may be transmitted through the rack verticals (48), distributed through the foot pads (10) and onto a sturdy floor. The rack width (15) bears directly beneath the cap (21), and may also serve as an anchorage point for the horticultural lights (24) to be mounted upon. Though the rack (11) in FIG. 4 describes two rows of troughs at three levels high, the rack (11) may conceivably be any number of rows wide at any length long, at any number of layers high. Should hallways for human access be required, the linear guides (12) may be extended across the hallway at heights that are unobtrusive for a human to navigate around. Brackets (13) are used to provide stiffness to the rack (11) shown in FIG. 4. Plumbing for drains (18) and pressurized lines may be routed within the proximity of the rack verticals (48).

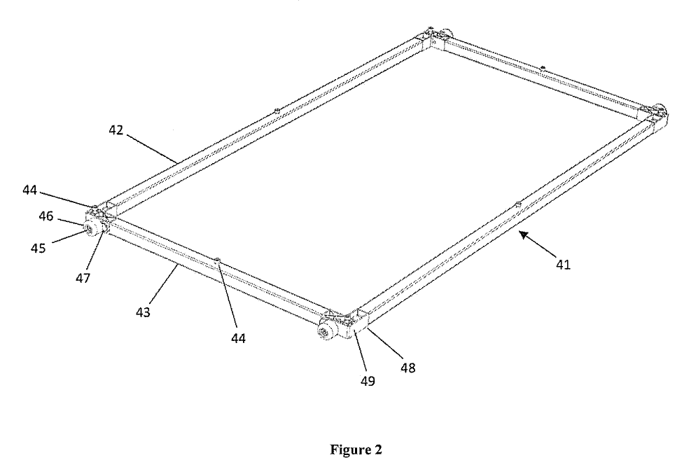

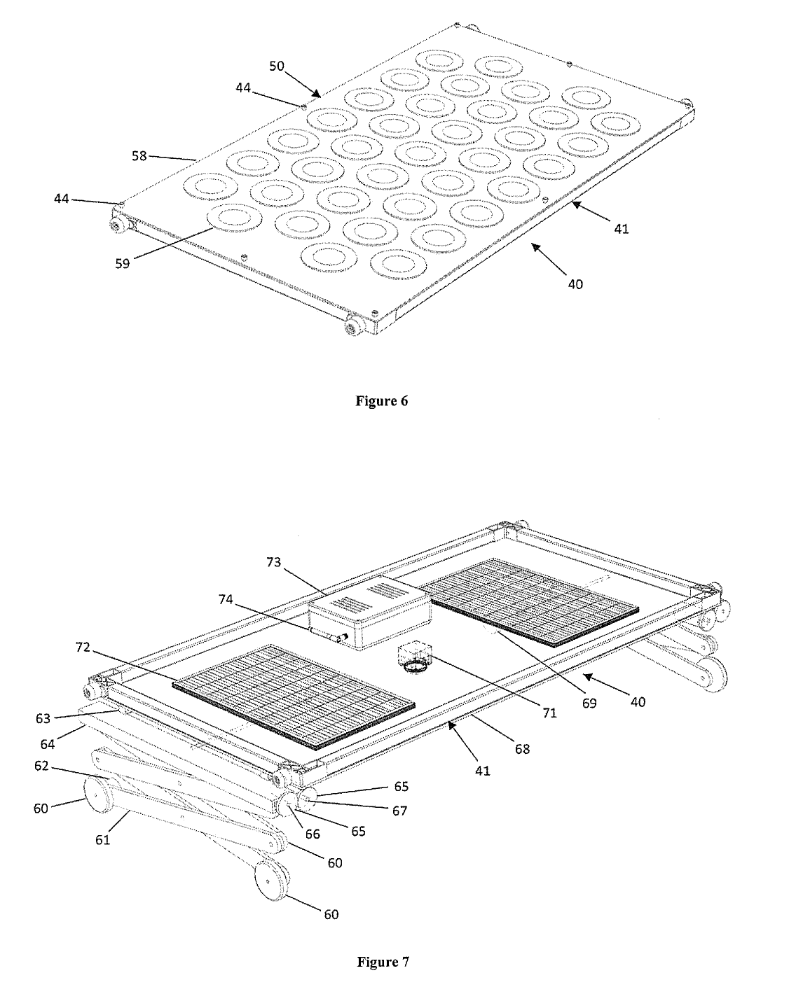

As the linear guides (12) are located at opposite ends of the rack (11) shown in FIG. 4, the carriage-manipulator system shown in FIG. 2 may freely navigate along the width of the rack (11) while still having access to the template frames derived in FIGS. 3, 4, 5, 6, and 7. The carriage (80), shown in FIGS. 14 and 15, provides vertical linear motion via its linear guides, a drive (27), and a linear guide. Other forms of linear actuation, such as friction roller, lead screw, scissor mechanism, or fluidic actuator may also be suitable. The carriage vertical provides structure to the overall integrity of the carriage (80) shown in FIG. 14. Bearings may be tensioned to fit securely onto the linear guides (12). The upper housing may store electronics, hyperspectral cameras, or sensors for querying the template frame. The template frame bin serves as a temporary site for storing a template frame, expressed in FIGS. 6.1-6.5. The lower housing is intended to house at least one motor for controlling motion along the linear guides (20), though it could also be placed in the upper housing (26). In alternative derivations, the motors controlling motion along the linear guides may be housed remote of the carriage (80) in FIG. 2, in the upper housing (26), or the lower housing.

In another preferred embodiment, the manipulator (82), shown in FIGS. 3.1 and 3.2, is intended to manipulate the template frame, shown in FIGS. 6.1-6.5, through a mode of actuation. The frame (28) is bonded together with brackets (29). Tensioned bearings (44) provide controlled linear motion about the linear guide (20). A motor (41) provides power to a belt (43), which transmits torque to a shaft (46), moving an open-ended belt that is coupled to the linear extensor (37). As the linear extensor (37) is secured within tensioned bearings (45), linear motion is possible with the motor is driven. In alternative derivations, the linear extension function could be accomplished through fluidic actuation, a lead screw, linkage, magnetic suspension, and more. Electronics (40) are housed within the frame (28), and may include an RFID sensor for registering a template frame. A camera (47) may be used to register a tag (47) as a mode of localization.

As shown FIG. 6.1, to acquire a template frame (41)in one preferred embodiment, the linear extensor is oriented directly over the top surface of the template frame. In the embodiment shown in FIGS. 3.1 and 3.2, magnetic solenoids (35) are energized and attract a ferrous material (58). The magnetic solenoid (35) is attached to a force sensor (47), which is secured to a mount (30). To place a frame template back into the rack (11) in FIG. 2, the frame template may be temporarily stored onto the temporary frame bin (23). The hinge (38) is pivoted through the actuation of a servo (39), causing the magnetic solenoids (35) to clear the indexing thumb (36). The manipulator (82) shown in FIGS. 3.1 and 3.2 is oriented in front of a cutout feature of the cap (21), and extended through the actuation input of the motor (41). The indexing thumb (36) comes into contact with the frame (17) of the template frame, and continues to exert force until the template frames within the trough have indexed one full template frame (41) width.

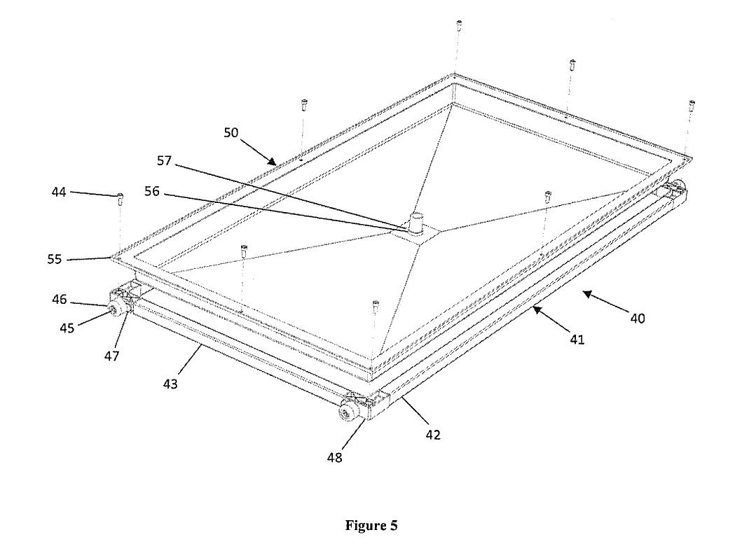

In one preferred embodiment, as shown in FIGS. 5.1-5.4, the trough resides within the rack (11) expressed in FIG. 2, and houses template frames and plumbing. The guide (50) bears features for securing template frames and mitigating risk for buckling. As shown in FIG. 5.3, the guide (50) can be seen with a three-sided feature to fully enclose a template frame. In FIG. 5.4, the guide (50) has a two-sided feature to allow for the manipulator (82), in FIGS. 3.1 and 3.2, to access the template frames. The trough runner (49) bears a flange feature for bearing onto rack runner (14), features for mounting the guide (50), and a small pitch to motivate water drainage towards its center. An overflow drain (51) assures no risk for water to flood the trough in FIG. 5.1, whereas a drain (52) provides a smaller orifice for water to fully evacuate the trough. The cap (21) retains water, bears a cutout feature for the indexing thumb (36) to engage the frame (17), and has a tag (47), which may be registered from the camera (47), or a wireless sensor. An orifice (53) provides an input for irrigation, consisting of but not limited to ebb-and-flow, float raft, and aeroponics.

As depicted in FIGS. 3-7, the template frame (41) in one preferred embodiment is compatible with features demonstrated on the manipulator (82) in FIGS. 14 and 15, and also the trough of FIGS. 8-10. The template frame (41) comprises a tag (47), which may be but is not limited to RFID, or a binary matrix. Grasping features, such as a flange for a forklift approach, features for vacuum holding, latches, or keys may also be considered. Low friction bearings (56) nest within the guide (50), permitting motion along its length. A rigid frame (17) serves as a surface for mounting farm peripherals, such materials for cultivating product (FIG. 6.1), materials for sensing the environment (FIG. 6.2), materials for actuation (FIG. 6.3), materials for propelling fluids (FIG. 6.4), and materials for cleaning the trough (FIG. 6.5).

Other contemplated embodiments, as shown in FIGS. 4 and 5, of the template frame (41) comprise of features such as a deep bin (50) or shallow bin (55) to retain organic matter. A lid (53) may be included to regulate environment within the deep bin (50). Fasteners (44) hold the template frame (41) to the frame insert (40).

Other contemplated embodiments of the template frame (41) comprise features such as solar panels (59) that may provide power to be stored in a battery (64). In one embodiment depicted in FIG. 7, an electronics enclosure (73) may store power generated from a solar panel (72) and perform sensory and control tasks through the locomotion along a track assembly (18). Wheels may be deployed through active actuation from the assistance of motors. A linkage (61) system allows for the height of the template frame to be adjusted. An antenna (74) facilitates wireless communication to a central hub. A camera (71) provides data in the visible, infrared, or ultraviolet spectra.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. An apparatus for autonomous controlled environment agriculture comprising:
a rack;
a plurality of track assemblies fixedly connected to said rack;
a plurality of template frames wherein each of said template frames may be movably connected to and supported in a position by one of said track assemblies;
a frame insert operably connected to each of said template frames;
a carriage movably connected to said rack; and
a first manipulator operably connected to said carriage configured to autonomously retrieve and move one of said template frames from a first position supported by a first one of said track assemblies to a second position supported by a second one of said plurality of track assemblies.

2. The apparatus of claim 1 wherein said template frame includes a tag having RFID or optical characteristics for identification or machine localization.

3. The apparatus of claim 2 wherein said RFID feature operates at 125-134 KHz, 13.56 MHz, 433 Mhz, or 860-960 MHz and is actively or passively powered.

4. The apparatus of claim 3 wherein said tag may consist of a visual matrix or alphanumeric identifier.

5. The apparatus of claim 1 wherein said template frame is configured for low friction movement along said track.

6. The apparatus of claim 1 wherein said template frame includes features for lifting through the forceful input of a manipulator.

7. The apparatus of claim 1 wherein said frame insert may be configured to facilitate growth of organic systems.

8. The apparatus of claim 1 wherein said frame insert may be configured to house electromechanical equipment.

9. The apparatus of claim 1 further comprising an LED light module configured to provide photosynthetically active radiation to said track assembly.

10. The apparatus of claim 1 further comprising a fan module configured to provide forced convection along the length of said track assembly.

11. The apparatus of claim 1 wherein said rack is placed within an environmentally-controlled enclosure to regulate air quality.

12. The apparatus of claim 11 wherein said environmentally-controlled enclosure includes a chemical mixing and delivery system to administer chemical mixtures to said track assemblies.

13. A method for autonomous controlled environment agriculture comprising the steps of: in which may be autonomously moving a template frame from a first location to a second location.

14. The method of claim 13 further comprising the steps of inserting or removing a tray from a tray assembly or a conveyor line through autonomous assistance.

15. The method of claim 13 further comprising the step of applying an external force to said template frame to facilitate linear motion along a track assembly.

16. The method of claim 13 further comprising the step of autonomously organizing and configuring a plurality of tray assemblies to an appropriate environment.

17. The method of claim 13 further wherein said template frame is part of an assembly comprising a a rack;
a plurality of track assemblies fixedly connected to said rack;
a plurality of template frames wherein each of said template frames may be movably connected to and supported in a position by one of said track assemblies;
a frame insert operably connected to each of said template frames;
a carriage movably connected to said rack; and
a first manipulator operably connected to said carriage configured to autonomously retrieve and move one of said template frames from a first position supported by a first one of said track assemblies to a second position supported by a second one of said plurality of track assemblies.

18. An apparatus for autonomous controlled environment agriculture comprising a distributed electromechanical system configured to perform tasks pertinent to maintaining and understanding a growing environment.

19. The apparatus of claim 18 in which said electromechanical system may freely navigate throughout said growing environment.

20. The apparatus of claim 19 further comprising:
a rack;
a plurality of track assemblies fixedly connected to said rack;
a plurality of template frames wherein each of said template frames may be movably connected to and supported in a position by one of said track assemblies;
a frame insert operably connected to each of said template frames;
a carriage movably connected to said rack; and
a first manipulator operably connected to said carriage configured to autonomously retrieve and move one of said template frames from a first position supported by a first one of said track assemblies to a second position supported by a second one of said plurality of track assemblies.
